(19) United States
(12) Patent Application Publication
(10) Pub. No.: US 2009/0316113 A1
(43) Pub. Date: Dec. 24, 2009

(54) MAPPING OPTICAL IMAGES ONTO AN IMAGE SENSOR BY MEANS OF A FIBER OPTIC FACE PLATE OR A FIBER OPTIC TAPER

(75) Inventors: Juergen Ernst, Erlangen (DE); Guenther Kostka, Erlangen (DE); Peter Schmitt, Erlangen (DE); Dieter Schmidt, Nuernberg (DE); Andreas Jobst, Nuernberg (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignee: Fraunhofer-Gesellschaft Zur Förderung Der Angewandten Forschung E.V., Münich (DE)

(21) Appl. No.: 12/306,325

(22) PCT Filed: Jun. 26, 2007
(86) PCT No.: PCT/EP2007/005648

§ 371 Date: Jan. 22, 2009

(30) Foreign Application Priority Data
Jun. 30, 2006 (DE) 10 2006 030 273.7

(51) Int. Cl. H04N 5/225

(52) U.S. Cl. 352/244; 348/359; 348/E05.027

(57) ABSTRACT

A capturing apparatus includes an optical input, a fiber optic face plate arranged at the optical input, an image sensor, and optics for mapping a real image at an optical output of the fiber optic face plate onto the image sensor in a predetermined scale.

### BACKGROUND OF THE INVENTION

The present invention relates to mapping optical images onto an image sensor by means of a fiber optic face plate and/or a fiber optic taper, and particularly to adapting mechanical motion picture cameras to electronic image detection by means of a fiber optic face plate and/or a fiber optic taper.

Motion picture cameras generate a sequence of real images of an object in an image plane. A real image is generated of the object by means of optical mapping and may, in contrast to a virtual image, for example, be stored by exposure of a conventional photographic film and/or made visible by means of a focusing screen (diffusion screen). To this end, the conventional photographic film of the focusing screen is brought as closely to the image plane as possible, so that the real image has the maximum sharpness possible. Apart from these possibilities, a real image may also be digitized and stored by an image sensor brought into the image planes.

Usually, a motion picture camera includes two mechanical assemblies: first, the camera housing, in which the entire mechanics and optics reside, and secondly, the replaceable film cassette containing the photographic film and a simple mechanical system for the film drive.

FIG. 8 shows a conventional motion picture camera 800. The motion picture camera 800 comprises a camera housing 810, an objective 820, and a film cassette 830. The camera housing 810 of a motion picture camera 800 contains all substantial mechanical and optical functional elements. A photographic film is contained in rolled-up fashion in the replaceable film cassette 830. The detachable objective 820 generates a real image at the location of the film. To this end, the objective 820 receives the rays originating from an object and maps them onto a real image in an image plane 110 via a lens system, for example. In the conventional motion picture camera 800, this real image is stored by exposure of the chemical film material. To this end, the film material is guided to the image plane 110 via a corresponding mechanical device and exposed there.

For many applications it is further desirable for the image not only to be stored on a conventional photographic film by exposure, but also to be electronically captured and stored by means of an electronic image sensor. An electronic cassette, which contains an image sensor and further electronic components instead of the film, is to serve this purpose. On the outside, this cassette resembles a normal film cassette. The camera housing 810 in no way is to be changed, so that conventional film cassettes 830 with photographic film also may still be used, as well as the electronic cassette, as an alternative.

One problem consists in the fact that, due to the mechanical construction of the motion picture camera 800, placement of an electronic image sensor at the location of the original photographic film, which means in the image plane, is not possible. Changing the optical ray path in the camera housing or displacing the real image into the electronic cassette would concern the camera housing 810 and is excluded because of the intended alternative use of conventional film cassettes.

Using special objectives, which would have to be newly developed for this application, is not desired for practical and economical reasons either. Furthermore, the available image sensor comprises an optically active area, the size of which generally does not match the size of the film window, i.e. the negative format on the photographic film. Hence, before being capable of being detected by the electronic image sensor, the real image has to be scaled correspondingly, i.e. size or scale adaptation has to be performed.

An obvious solution would be the integration of further optics (relay optics) in the electronic cassette, with which the real image could be projected from the image plane onto the sensor area. What is disadvantageous in this option is that, due to the limited width of the electronic cassette, only a very limited diameter of the relay optics would be possible, which leads to a drop in brightness in the corners of the image (vignetting) as well as a general loss of quality, particularly with large apertures of the employed objectives. Basically, relay optics in the cassette could be optimized only for a certain objective, but not for a multiplicity of various ones.

A further, technically obvious and possible solution would be using a focusing screen at the location of the original film and relay optics projecting the image from the focusing screen onto the sensor. By way of the focusing screen, the optical paths of the objective and the relay optics are at least partially decoupled from each other. However, this solution has two substantial drawbacks:
1. The granulation (roughness) of the focusing screen significantly aggravates the quality of the image.
2. A possible electronic/digital correction of the granulation fails because of the fact that the decoupling between objective and relay optics is not ideal. Hence, the granulation pattern of the focusing screen detected by the sensor depends on the objective itself and on its settings, i.e. aperture, distance, zoom factor. Individual correction is not feasible for all possible parameter combinations.

### SUMMARY

According to an embodiment, an electronic cassette may have: a cassette housing with an opening as an optical input, wherein the cassette housing is shaped such that it can be inserted into a motion picture camera instead of a film cassette; a fiber optic block arranged in the proximity of the optical input and having an optical output, so that a sequence of real images generated by the mechanical motion picture camera can be transmitted from the fiber optic block to the optical output; and a capturer for capturing a real image at the optical output of the fiber optic block.

The present invention is based on the finding that a real optical image with an image size can be transmitted by a fiber optic face plate with an optical input and an optical output from an image point, and then the image size can be adapted by optics (relay optics, more specifically) to a size of a sensor area of an electronic image sensor. Furthermore, the present invention is based on the finding that a real optical image with an image size can be transmitted from an image point to an electronic image sensor by means of a fiber optic taper comprising an optical input and an optical output of different cross-sectional size and be scaled correspondingly.

According to an embodiment, the fiber optic face plate together with the relay optics and the image sensor, or the fiber optic taper together with the image sensor is accommodated in an electronic cassette such that the electronic cassette may replace a conventional film cassette 830 in a motion picture camera 800. The position of the optical input of the fiber optic face plate or the optical input of the fiber optic taper here coincides with the position of the conventional photographic film of a conventional film cassette 830 if possible, i.e. the optical input is in the image plane of the motion picture camera 800.

Hence, in the embodiment, a conventional photographic film in a mechanical motion picture camera 800 can be replaced by electronic image detection (electronic image sensor in the broadest sense), without mechanical/optical alteration of the camera housing 810.

Hence, a so-called fiber optic face plate or a fiber optic taper is used instead of a focusing screen, according to the invention. The fiber optic face plate is a plane-parallel plate including many millions of glass fibers aligned in parallel. Since the fibers are strictly ordered, an image can be transmitted from the one side of the plate (optical input) to the other side (optical output) without any considerable distortion. This image now is mapped onto the image sensor by special relay optics in the right scale. On the other hand, the fiber optic taper is a tapering block of many millions of glass fibers running in orderly fashion. Thereby, an image can be transmitted from the one side (optical input) to the other side (optical output), and the image size may be changed at the same time. The optical input, i.e. the side of the fiber optic taper facing away from the sensor, is brought to the place of the real image of the motion picture camera 800. The mapping scale is chosen so that the image size of the film window is adapted to the size of the light-sensitive sensor area.

Accordingly, at the location of the real image there is the optical input of the fiber optic taper. The real image is passed through the fiber optic taper and at the same time enlarged or shrunk. Upon exiting the fiber optic taper, the image directly impinges on the sensor area, i.e. the light-sensitive area of the sensor. Correspondingly, area image sensors such as pixel arrays, such as in CCD or CMOS technology, may be used as image sensors in the present invention. Thus, the image may be sampled electronically, with the resulting electronic signal then being digitized if necessary.

In one embodiment, the fiber optic taper is glued directly onto the image sensor with a suitable method. So as to suppress Moiré effects as much as possible, the thickness of the glue layer or another optical coupling medium is adjusted in a defined manner. Thereby, intentional blooming between the fibers develops, which leads to a weakening of Moiré effects.

If no scale adaptation between the image generated by the camera objective and the sensor area of the image sensor is necessary when using a fiber optic face plate, the relay optics may be omitted, according to the invention. The fiber optic face plate then would be glued directly onto the image sensor with suitable methods. So as to suppress Moiré effects as much as possible, the thickness of the glue layer or another optical coupling medium has to be adjusted in a defined manner. Thereby, intentional blooming between the fibers develops, which leads to a weakening of Moiré effects.

In further embodiments, the image quality may be improved as follows. Anti-reflection coating of the optical input and/or optical output of the fiber optic face plate or the fiber optic taper suppresses undesired reflections and thus leads to an improvement in the light yield. Likewise, an arched design of the optical input and/or optical output and/or use of a lens may lead to the fact that an incoming amount of light is forwarded as optimally as possible to the image sensor. Finally, the spectral composition of the radiation impinging on the sensor may be changed and adapted to certain requirements by means of UV (ultraviolet) and/or IR (infrared) filters or by means of color filters brought into the optical path.

Inventive embodiments of the present invention comprise a series of advantages and improvements with respect to conventional technology. As opposed to using a focusing screen, the glass fibers are significantly smaller than the granulation of a focusing screen in the case of a corresponding choice of the fiber optic face plate or the fiber optic taper, so that the homogeneity, and hence the quality, of the image is significantly higher. A further advantage consists in the mechanical robustness (scratches, contamination) of a fiber optic face plate or a fiber optic taper as compared with a focusing screen. Moreover, according to the present invention, no alterations are necessary in existing motion picture cameras, and changeover to digital image detection simply is by replacing the conventional film cassette by an electronic cassette.

### BRIEF DESCRIPTION OF THE DRAWINGS

Embodiments of the present invention will be detailed subsequently referring to the appended drawings, in which:

FIG. 1 is a cross-sectional view of a first capturing apparatus according to an embodiment;

FIG. 2 is a cross-sectional view through an electronic cassette with built-in first capturing apparatus;

FIG. 3 is a cross-sectional view of a second capturing apparatus with a fiber optic taper;

FIG. 4 is a cross-sectional view through an electronic cassette with built-in second capturing apparatus;

FIGS. 5a-b show a schematic representation for illustrating the Moiré effect;

FIG. 6 is a cross-sectional view of an adhesive gap with introduced spacers;

FIG. 7 is a cross-sectional view through a fiber optic face plate with glued-on lens;

FIG. 8 shows a motion picture camera with a conventional built-in film cassette.

### DETAILED DESCRIPTION OF THE INVENTION

Before explaining the present invention in greater detail in the following on the basis of the drawings, it is pointed out that the same elements in the figures are provided with the same or similar reference numerals, and that repeated description of these elements will be omitted.

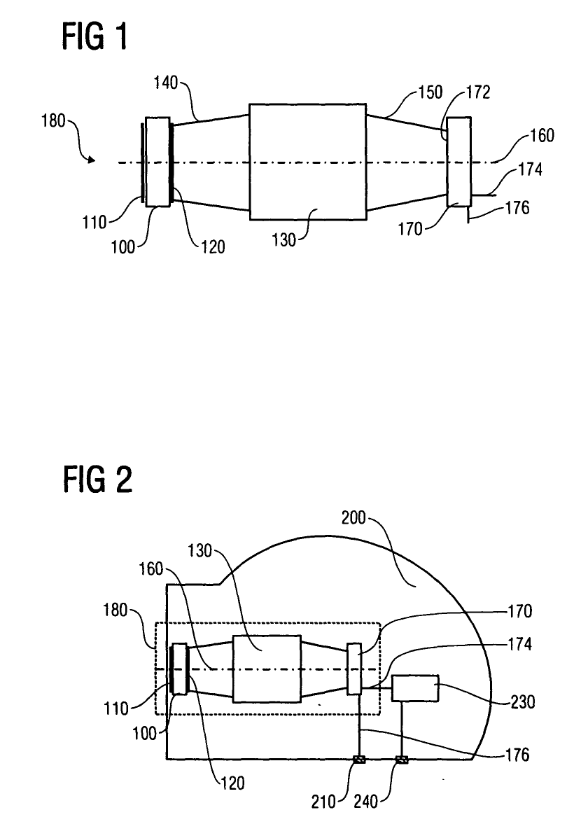

FIG. 1 shows a first capturing apparatus 180 for electronic imaging or image detection. The first capturing apparatus 180 includes a fiber optic face plate 100 having an optical input 110 and an optical output 120, as well as relay optics 130 and an image sensor 170 with a sensor area 172 and having a control and memory terminal 174 and a supply terminal 176. The first capturing apparatus 118 is aligned along an optical axis 160.

In an embodiment, the optical input 110 is located at a point where a real image develops in an image size. The real image is transmitted by the fiber optic face plate 100 and again appears as a real image at the optical output 120. An exiting light path 140 reaches the relay optics 130 mapping the real image from the optical output 120 onto the sensor area 172 of the image sensor 170. From the real image, the image sensor 170 at first generates an electronic signal, which may here exemplarily be read out in form of a data stream at the control and memory terminal 174 after digitization. Moreover, the image sensor 170 is attached to an external voltage source via the supply terminal 176.

The relay optics 130 thus serves for size adaptation of the image appearing at the optical output 120 to a size or cross-section of the sensor area 172 of the image sensor 170. Thereby, it is to be prevented that image information is lost and a maximum of light intensity enters the image sensor 170. In the embodiment shown here, the sensor area 172 of the image sensor 170 has a smaller cross-section than the optical output 120 of the fiber optic face plate 100. The relay optics 130 in this embodiment hence shrinks the real optical image from the optical output 120 to the image sensor 170. The scales here have only been chosen exemplarily and may be different in other embodiments.

FIG. 2 shows a cross-section of an electronic cassette with inserted first capturing apparatus 180 as described in FIG. 1. The control and memory terminal 174 of the image sensor 170 here is attached to a control and memory means 230, which in turn is connected to a data output 240. Furthermore, the electronic cassette 200 comprises a current or voltage terminal 210 connected to the supply terminal 176 of the image sensor 170.

Here, the first capturing apparatus 180 is arranged in the electronic cassette 200 such that the optical axis 160 coincides with an optical axis of the motion picture camera 800 if possible. With the electronic cassette 200 inserted into the motion picture camera 800, a sequence of real images appear at the optical input 110 during operation of the motion picture camera 800. These real images are transmitted by the fiber optic face plate 100 and detected by the replay optics 130 at the optical output 120 and changed in scale or size so that the image size corresponds to the size of the sensor area 172 of the image sensor 170 as much as possible. The image sensor 170 here is electronically attached to a voltage source via the terminal 210 and transmits the electronic signals to the control and memory means 230 via the control and memory terminal 174. The digitized real images are stored temporarily there and can be fetched at the data output 240.

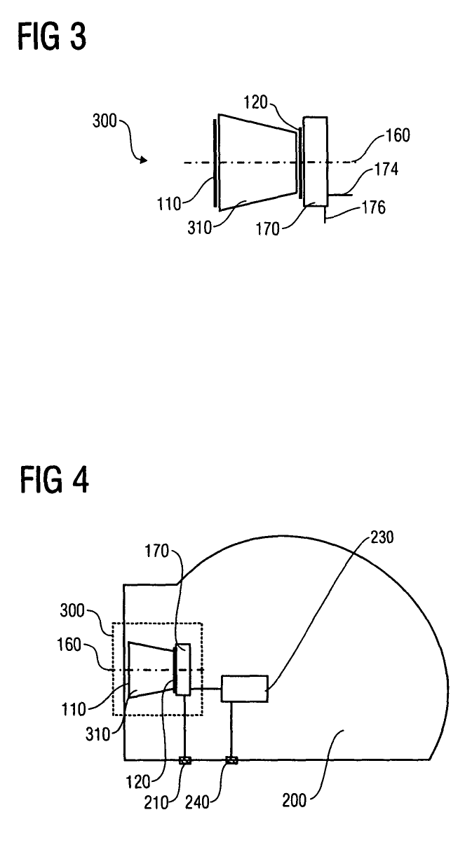

FIG. 3 shows a second capturing apparatus 300 for electronic image detection. The second capturing apparatus 300 includes a fiber optic taper 310 with an optical input 110 and an optical output 120, which corresponds to the sensor area 172 of the image sensor 170. The fiber optic taper 310 and the image sensor 170 are arranged along the optical axis 160.

Compared to the third capturing apparatus 180, the second capturing apparatus 300 does not comprise relay optics 130. Adapting a scale of the real images at the optical input 110 is done by the fiber optic taper 310 in the second capturing apparatus 300. Similar to the fiber optic face plate 100, the fiber optic taper 310 includes a multiplicity of glass fibers, the cross-sections of which taper from the optical input 110 to the optical output 120 in this embodiment, however. Advantageously, the fiber optic taper 310 is chosen such that the scale or cross-section of the optical input 110 corresponds to an image size of the real images generated by the motion picture camera 800. Furthermore, the fiber optic taper 310 may have has a scale or cross section of the optical output 120 corresponding to the size or cross section of the sensor area 172 of the image sensor 170 as much as possible.

In further embodiments, these scales may be different, i.e. the cross-section of the sensor area 172 of the image sensor 170 may be greater than or equal to the cross-section of the optical input 110. If both scales match, a fiber optic face plate may be used instead of a fiber optic taper 310.

FIG. 4 shows a cross-section of an electronic cassette 200 with an inserted second capturing apparatus 300. The second capturing apparatus 300 here is attached to a current or voltage terminal 210 via the supply terminal 176, and the memory and control terminal 174 is connected to the control and memory device 270. The image sensor 170 samples the real optical images and generates a corresponding signal, which is passed to the control and memory unit 230, where the electronic images may be stored temporarily and/or read out as a data stream at a data output 240.

The electronic cassette 200 is formed such that it may be inserted in a motion picture camera 800 instead of a conventional film cassette 830. Furthermore, the second capturing apparatus 300 is arranged in the electronic cassette 200 so that the optical axis 160 coincides with the optical axis of the motion picture camera 800 as much as possible. Furthermore, the fiber optic taper 310 here is placed such that the optical input 110 is located where the film material is exposed in a conventional film cassette 830, if possible. Like in the embodiment described in FIG. 3, the detected real images developing at the optical input 110 are transmitted to the image sensor 170 by the fiber optic taper 310 with concurrent scale adaptation to the sensor area 172 and are sampled in the image sensor 170. The corresponding digital images are stored temporarily in the control and memory means 230 and may be read out via the data output 240. Current or voltage supply here takes place via a voltage input 210.

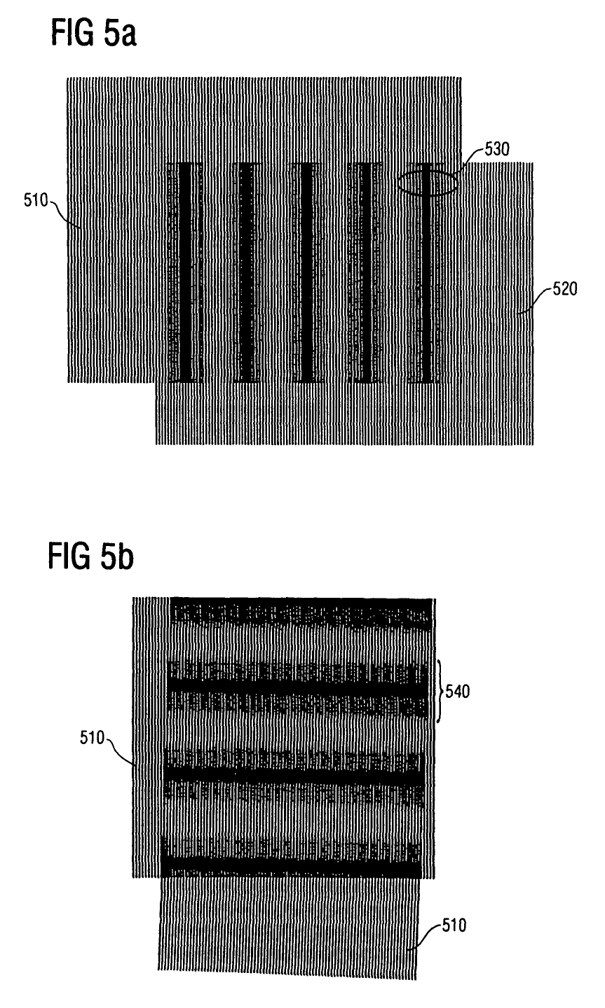

FIGS. 5a und 5b illustrate Moiré effects, which may develop in the case of a superimposition of rasters and lines and are noticeable due to new lines or Moiré structures developing. FIG. 5a shows the superimposition of a line grid 510 with a line grid 520 only differing slightly in their grid constants (line distance). Long-period brightness modulations 530, the distances and sizes of which depend on the various grid constants of the grids 510 and 520, develop in the case of the superimposition. In FIG. 5a, both grids 510 and 520 are arranged in parallel, so that the Moirè effect only occurs if the grid constants differ from each other. In contrast, FIG. 5b shows an example for the Moiré effect in which two uniform grids 510 having the same grid constant, but twisted relatively to each other, i.e. intersecting at an intersection angle, are illustrated. Moirè structures, the sizes of which depend on the grid constant on the one hand and on the intersection angle of the twisted grids on the other hand, also develop here.

However, Moiré effects not only develop by way of linear grids, but also by way of rasters as occurring in the present invention. Here, the form and shape of the Moiré structures are determined by different raster resolutions and are especially heavily pronounced if the raster resolutions only differ slightly.

According to the present invention, the image sensor 170 samples the obtained real image in raster-shaped manner when digitizing, on the one hand, and the optical output 120 of the fiber optic face plate 100 or the fiber optic taper 310 provides a raster-shaped reproduction of the real image at the optical input 110, on the other hand. The raster of the fiber optic face plate 100 or the fiber optic taper 310 here develops by way of glass fibers connecting the optical input 110 to the optical output 120, and the thickness thereof determines the raster resolution. The image sensor 170 samples the real image in raster-shaped manner with a raster width given by the pixel size of the image sensor 170. Thus, Moiré effects occur when relay optics 130 is not necessary due to equal image sizes of the fiber optic face plate 100 and the sensor area 172 and the fiber optic face plate 100 is glued directly onto the sensor area 172. Moreover, Moiré effects are to be expected in the second capturing apparatus 300, in which the fiber optic taper 310 is glued directly onto the sensor area 172.

Occurring Moiré effects are a result of a violation of the sampling theorem and cannot be avoided. A large-scale weakening, so that the Moiré effects are not perceivable visually, may be done by not gluing the optical output 120 of the fiber optic taper 310 (or the fiber optic face plate 100) directly onto the sensor area 172, but by connecting same via an adhesive gap (or air gap or gap filled with an optical coupling medium) instead. Hence, a superimposition of a light beams from different fibers occurs. This blooming leads to a weakening of Moiré effects.

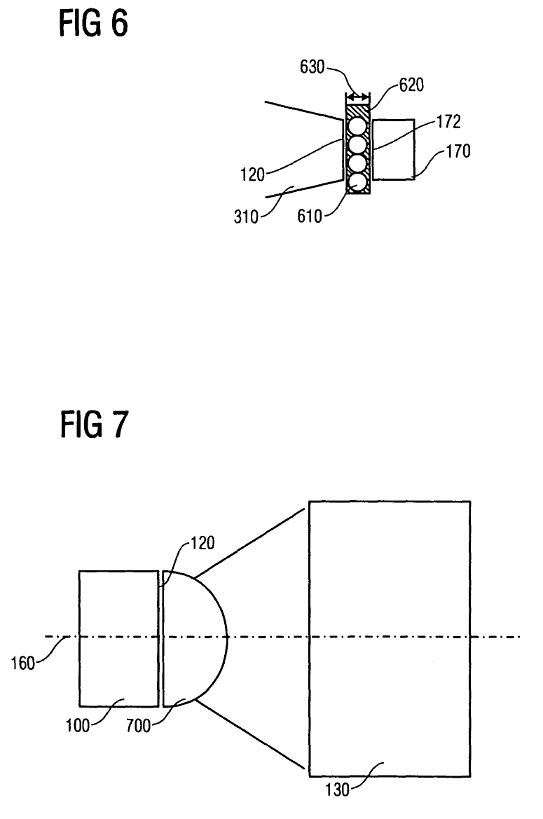

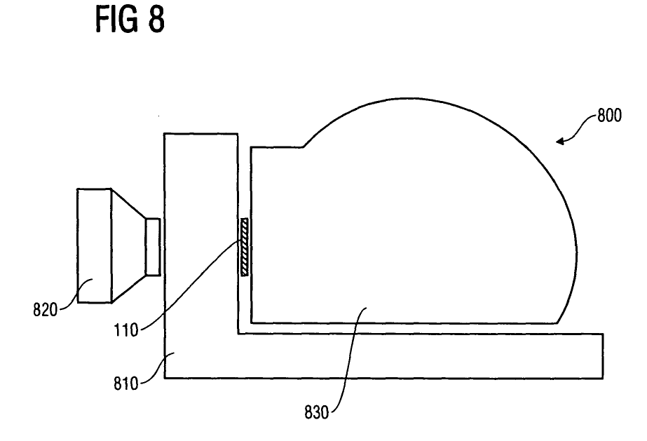

FIG. 6 shows a cross-sectional view through an adhesive gap with a glue material 620 with introduced spacers 610 between the optical output 120 of the fiber optic taper 310 and sensor area 172 of the image sensor 170. The introduced spacers 610 as well as the glue material 620 consist of an opaque material, and the spacers 610 are arranged so that they adjust a suitable adhesive gap thickness 630. The suitable adhesive gap thickness 630 is chosen such that the Moiré effects are suppressed as much as possible in the case of weakening of the image sharpness. The suitable adhesive gap thickness 630 here particularly depends on the raster resolutions of the fiber optic taper 310 and the image sensor 170, but the material employed also has some influence. For example, glass balls of a certain thickness may be used as spacers. The adjustment of the gap thickness may also be done by means and methods other than spacers.

In further embodiments of the present invention, the Moiré effect, which cannot be eliminated completely, may also be suppressed by using a suitable image processing algorithm. This may, for example, be done by using special software in the control and memory device 230.

FIG. 7 shows a cross-sectional view through a fiber optic face plate 100 with a glued-on lens 700 at the optical output 120 and downstream relay optics 130 aligned along the optical axis 160. The lens 700 has a shape so that the light beams from the fiber optic face plate 100 increasingly are directed into the relay optics to thereby increase image quality, particularly brightness.

In further embodiments of the present invention, the current or voltage supply of the electronic cassette may be effected via a battery or an accumulator, thus omitting the current or voltage terminal 210. Likewise, in a further embodiment, the control and memory device 230 may, for example, have only one memory chip storing the electronically detected images. If the memory chip is replaceable, for example, the electronic cassette 200 does not have to comprise any further data output 240.

Moreover, in further embodiments of the present invention, the fiber optic face plate 100 may be provided with a convexly arched surface on the side facing the sensor to direct the exiting light beams toward the optical axis 160 and hence increasingly into the relay optics 130. Thereby, the luminosity of the overall system is increased. The convex arching may either be achieved by corresponding surface treatment of the fiber optic face plate 100 itself or by gluing on a corresponding plane-convex lens 700 as mentioned.

Inventive embodiments of the present invention comprise a series of advantages and improvements as opposed to conventional technology. As opposed to using a focusing screen, the glass fibers are significantly smaller than the granulation of a focusing screen in the case of a corresponding choice of the fiber optic face plate 100 or the fiber optic taper 310, so that the homogeneity, and hence the quality, of the image is significantly higher. A further advantage is the higher mechanical robustness (for example to scratches and contaminations, which may settle into the rough surface of a focusing screen) of a fiber optic face plate 100 or fiber optic taper 310 as compared with a focusing screen. Moreover, no alterations are necessary in existing motion picture cameras 800, and a switchover to digital (electronic) image detection takes place by simply replacing the conventional film cassette 830 by an electronic cassette 200. Thus, the digital image detection is inexpensive and easy to realize. Moreover, the present invention enables unproblematic change between digital and conventional image detection by replacement of a conventional film cassette 830 by an electronic cassette 200. Already existing film cameras and their accompanying objectives may still be used further.

In further embodiments of the present invention, the fiber optic face plate 100 or the fiber optic taper 310 are anti-reflection coated on one or both sides for further improving image quality and brightness. There are different possibilities for anti-reflection coating. For example, depositing a system of one or more thin layers may produce a so-called interference filter, in which occurring interferences almost completely suppress a reflection of light in a wavelength range. On the other hand, reflections may also be suppressed if a thin layer has a corresponding refractive index. However, patterning the surface on an order of the wavelength of the incident light also efficiently suppresses light reflections.

According to the invention, the fiber optic face plate 100 or the fiber optic taper 310 may also be provided with a filter, e.g. a dielectric IR and/or UV filter, which keeps undesired radiation proportions away from the sensor and improves color reproduction of the image sensor, for example. Moreover, the fiber optic face plate 100 may be combined with a mass filter, for example for IR and/or UV radiation, according to the invention. A mass filter operates in accordance with the principle of absorption and may, for example, comprise plain or colored glass. The filters may either be brought into the optical path in a suitable fashion or realized by direct gluing onto the fiber optic face plate 100 or fiber optic taper 310, for example.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-21. (canceled)

22. An electronic cassette for a mechanical motion picture camera, comprising:
a cassette housing with an opening as an optical input, wherein the cassette housing is shaped such that it can be inserted into a motion picture camera instead of a film cassette;
a fiber optic block arranged in the proximity of the optical input and comprising an optical output, so that a sequence of real images generated by the mechanical motion picture camera can be transmitted from the fiber optic block to the optical output; and
a capturer for capturing a real image at the optical output of the fiber optic block.

23. The electronic cassette according to claim 22, wherein the fiber optic block is formed so that deflection of light beams passing through the fiber optic block occurs at the optical output.

24. The electronic cassette according to claim 23, wherein the fiber optic block comprises an arch causing deflection of the light beams at the optical output.

25. The electronic cassette according to claim 23, wherein a lens is arranged at the optical output of the fiber optic block to cause the deflection of the light beams at the optical output.

26. The electronic cassette according to claim 22, wherein the fiber optic block comprises anti-reflection coating.

27. The electronic cassette according to claim 22, further comprising a frequency-selective optical filter arranged between the fiber optic block and the image sensor.

28. The electronic cassette according to claim 27, wherein the filter comprises a dielectric infrared and/or ultraviolet filter.

29. The electronic cassette according to claim 22, wherein the capturer comprises an image sensor with a sensor area, wherein the sensor area is arranged at the optical output of the fiber optic block.

30. The electronic cassette according to claim 29, wherein the sensor area is arranged at a fixed distance from the optical output of the fiber optic block, and the fixed distance is chosen so that mapping errors as a result of an occurring Moiré effect are suppressed.

31. The electronic cassette according to claim 29, wherein the sensor area is glued onto the optical output of the fiber optic block by means of a glue having solid balls or spacers added.

32. The electronic cassette according to claim 22, further comprising a device for image processing formed such as to compensate mapping errors as a result of a Moiré effect.

33. The electronic cassette according to claim 22, wherein the fiber optic block is formed as a fiber optic taper, so that an optical entry area of the fiber optic block is greater or smaller than an optical exit area of the fiber optic block.

34. The electronic cassette according to claim 22, wherein the fiber optic block comprises a fiber optic face plate.

35. The electronic cassette according to claim 22, further comprising optics and an image sensor.
